(19) United States
(12) Patent Application Publication
(10) Pub. No.: US 2015/0135600 A1
(43) Pub. Date: May 21, 2015

(54) SASH MEMBER

(71) Applicant: SHIROKI CORPORATION, Fujisawa-shi (JP)

(72) Inventors: Kazuyoshi YOKOTA, Gamagori-shi (JP); Kenji SHIMIZU, Toyokawa-shi (JP)

(21) Appl. No.: 14/546,945

(22) Filed: Nov. 18, 2014

(30) Foreign Application Priority Data
Nov. 19, 2013 (JP) 2013-238549

(51) Int. Cl. B60J 5/04

(52) U.S. Cl. CPC B60J 5/0402; B60J 5/0412; B60J 5/0463
USPC 49/502

(57) ABSTRACT

A door sash includes a sash member including: a body portion having: a first sidewall facing one side of a door glass; a second sidewall facing the other side of the door glass; and a bottom wall that connects base ends of the first side wall and the second sidewall and faces a end face along a thickness direction of the door glass; and a fin portion which extends from a corner between the first sidewall and the bottom wall and has a surface flush with a surface opposite to a surface, which faces the door glass, of either one of the first sidewall and the bottom wall, and wherein the sash member is bent in a width direction of a vehicle.

### CROSS-REFERENCE TO RELATED APPLICATION

This application claims priority from Japanese Patent Application No. 2013-238549 filed on Nov. 19, 2013, the entire subject matter of which is incorporated herein by reference.

### TECHNICAL FIELD

This disclosure relates to a door sash having a sash member provided between an inner panel and an outer panel of a door and having a fin portion to which a bracket or the like is attached, and serving to guide a door glass to move up and down therealong.

### BACKGROUND

A description will now be made with reference to FIGS. 6 and 7. FIG. 6 is a view of a door, in which an outer panel is removed, as viewed from the outside of a vehicle, and FIG. 7 is a cross-sectional view taken along line VII-VII of FIG. 6.

A portion of an inner panel 11, other than front and rear edge part and a lower edge part, forms a expansion portion 12 expanding towards the inside of a vehicle. A center of the expansion portion 12 is provided with a working hole 13 via which a window regulator or the like (not shown) is attached in a space between the inner panel 11 and the outer panel.

A lower end of a door sash 15 is connected to the outside of the inner panel 11 made of aluminum. The door sash 15 includes an upper sash 16 configuring a front edge and an upper edge of the door sash 15, a rear sash 17 extending in a substantially vertical direction so as to form a rear edge of the door sash, and a lower sash as a sash member connected in proximity to the front end of the upper sash 16 and extending in a substantially vertical direction. The upper sash 16, the rear sash 17, and lower sash 18 are made of aluminum, respectively. Although not shown in the drawings, lower ends of the upper sash 16, the rear sash 17, and lower sash 18 are fixed by welding to the outside of the expansion portion 12. A window opening 19 is defined by the upper sash 16, the rear sash 17, and an upper edge of the expansion portion 12.

An annular weatherstrip member WS, which is annular member and is made from an elastic material, such as rubber or the like; are wound around the entire outer circumference (front, lower, and rear sides) of the expansion portion 12, and outer circumferences of the upper sash 16 and the rear sash 17.

As shown in FIG. 7, the lower sash 18 is an extruded or pultruded member made of aluminum. The lower sash 18 includes: a body portion 35, which has a first sidewall 35a facing one side of a door glass 21, a second sidewall 35b facing the other side of the door glass 21, and a bottom wall 35c that connects base ends of the first sidewall 35a and a second sidewalls 35b and faces an end face 21a along a thickness direction of the door glass 21; and a fin potion 30 extending from the bottom wall 35c.

When the lower sash 18 is extruded or pultruded, the fin portion 30 is entirely formed on the front surface of the lower sash 18 along the longitudinal direction (formed as a constant cross-sectional pultruded member). Since the lower side of the fin portion is removed after the extrusion or pultrusion has been performed, as shown in FIG. 6, only an upper side of the fin portion 30 is left.

A mirror bracket 32 for mounting a door mirror is disposed between the upper sash 16 and the lower sash 18. A rear end 33 of the mirror bracket 32 abuts against the outside of the fin portion 30, and they are connected by a rivet 34.

Further, a paint seal A1 is applied over the front surface of the body portion 35 of the lower sash, the fin portion 30, and the rear end 33 of the bracket along the whole length of the fin portion 30.

A front end 36 of the mirror bracket 32 faces an outer-side end face 37, which is located an outer side of the vehicle, of the upper sash 16 with a gap interposed therebetween. A paint seal A2 is applied over the front end 36 and the outer-side end face 37 along the whole length of the front end 36 (see e.g. 2007-145282).

### SUMMARY

However, since the fin portion 30 of the lower sash 18 as a sash member shown in FIGS. 6 and 7 is formed on a middle portion of the bottom wall 35c, there is a step between the fin portion 30 and the first and second sidewalls 35a and 35b.

Accordingly, the lower sash 18 has a complicated sectional shape, thereby causing low formability at the time of extrusion or pultrusion modling.

Further, the bending process is performed on the lower sash 18. However, if there is a step between the fin portion 30 and the first and second sidewalls 35a and 35b, a portion of a die for supporting the stepped portions becomes complicated, thereby causing a low bending workability.

Furthermore, when the fin portion 30 is cut, the cut face is not flush with, but slightly protrudes from the bottom wall 35c, thereby causing a problem in that a component such as a bracket or the like cannot be mounted over the cut face.

Accordingly, this disclosure is to provide a door sash having a sash member, which has good extrusion formability and good bending workability and in which a cut face of a fin portion does not protrude from the adjacent face.

A door sash of one aspect of this disclosure includes a sash member. The sash member includes: a body portion having: a first sidewall facing one side of a door glass; a second sidewall facing the other side of the door glass; and a bottom wall that connects base ends of the first side wall and the second sidewall and faces a end face along a thickness direction of the door glass; and a fin portion which extends from a corner between the first sidewall and the bottom wall and has a surface flush with a surface opposite to a surface, which faces the door glass, of either one of the first sidewall and the bottom wall, and wherein the sash member is bent in a width direction of a vehicle.

Other features of this disclosure will become more apparent from following embodiments and accompanying drawings.

According to this disclosure, a fin portion extends from a corner between the first sidewall and the bottom wall and has a surface flush with a surface opposite to a surface, which faces the door glass, of either one of the first sidewall and the bottom wall. That is, the fin portion has no step with respect to one of the first sidewall and the bottom wall.

Thus, the sectional shape of the lower sash is simplified, thereby improving formability in the extrusion or pultrusion molding.

Further, since the fin portion has no step with respect to one of the first sidewall and the bottom wall, a shape of a die becomes a simple shape, so that the sash member has good bending workability at the time of bending working.

Furthermore, the fin portion can be cut such that a cut face does not protrude from the adjacent face.

Other effects of this disclosure will be more apparent from following embodiments and accompanying drawings.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a cross-sectional view of a lower sash (sash member) according to an embodiment of this disclosure when taken along cutting line I-I of FIG. 2;

FIG. 2 is a view illustrating an entire configuration of a door sash, to which the lower sash is mounted, as viewed from the outside of a vehicle;

FIG. 3 is a cross-sectional view taken along a cutting line III-III of FIG. 2;

FIG. 4 is a perspective view of a mounting section between an upper sash and an upper portion of the lower sash, as viewed from the inside of a vehicle;

FIG. 5 is a view illustrating another embodiment;

FIG. 6 is a view illustrating door of which outer panel is removed, as viewed from the outside of a vehicle, in the background art; and

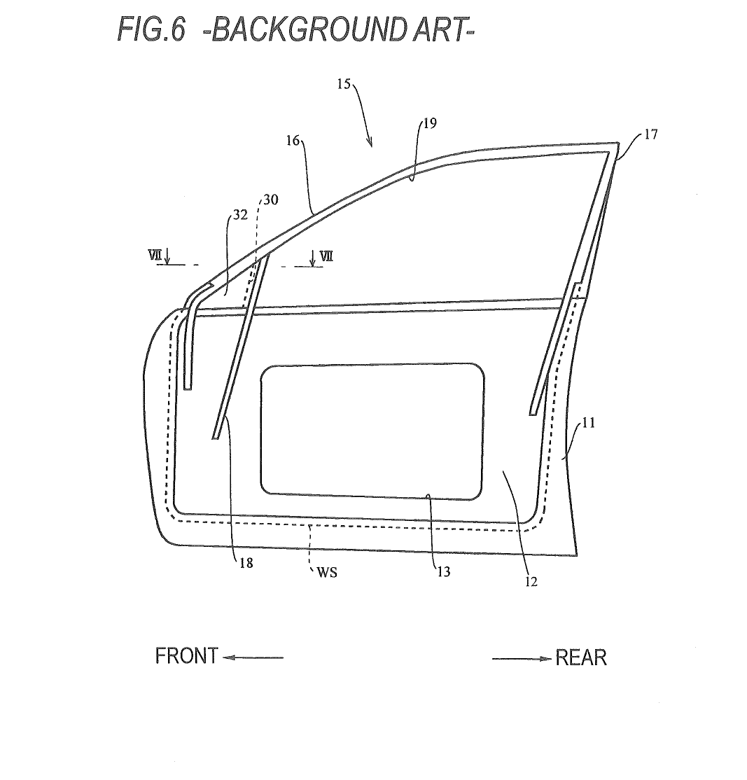

FIG. 7 is a cross-sectional view taken along line cutting line VII-VII of FIG. 6, in the background art.

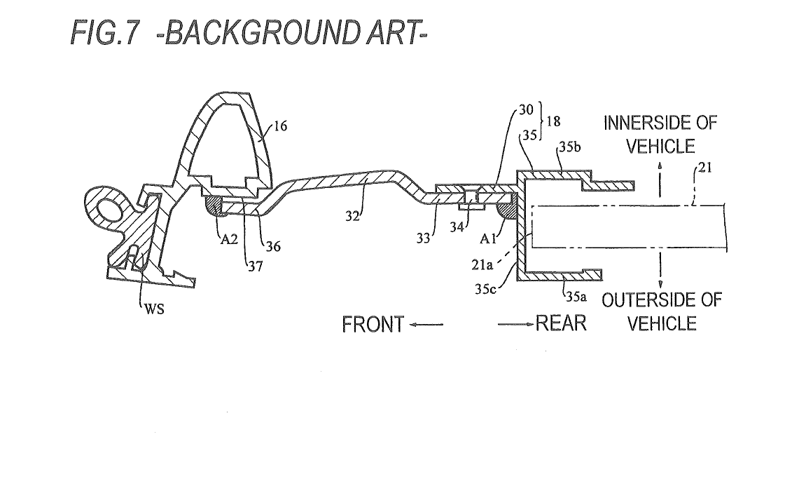

### DETAILED DESCRIPTION

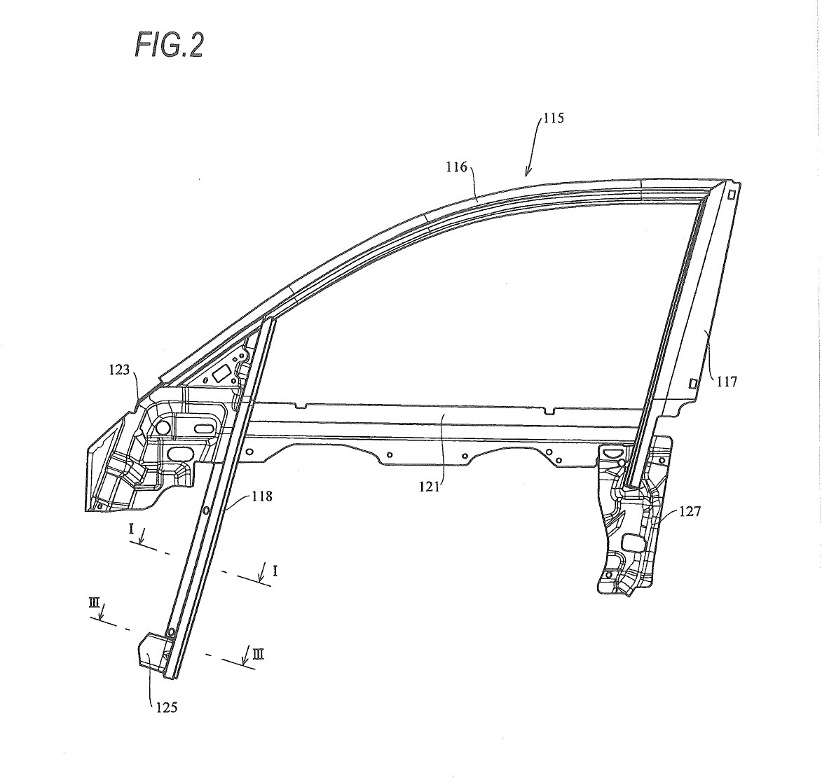

The entire configuration, as viewed from the outside of a vehicle, of a door sash having a lower sash (sash member) according to an embodiment of this disclosure will now be described with reference to FIG. 2.

The door sash 115 includes an upper sash 116 configuring a front edge and an upper edge of the door sash 115, a rear sash 117 extending in a substantially vertical direction so as to form a rear edge of the door sash, and a lower sash 118 as a sash member connected in proximity to the front end of the upper sash 116 and extending in a substantially vertical direction. The upper sash 116, the rear sash 117, and lower sash 118 are made of aluminum, respectively.

A door glass, which is not shown, moves up and down with being guided by the lower sash 118 and the rear sash 117.

A rear portion of a beltline reinforcement 121 is connected to a lower portion of the rear sash 117. A bracket 123 for mounting a door mirror is provided in a space defined between the periphery of the front end of the upper sash 116 and the lower sash 118. A front portion of the beltline reinforcement 121 is attached to the bracket 123.

A bracket 125 for fixing the lower sash 118 to an inner panel of the door is provided at the lower portion of the lower sash 118. A bracket 127 for mounting a lock device or the like is provided at the lower portion of the rear sash 117.

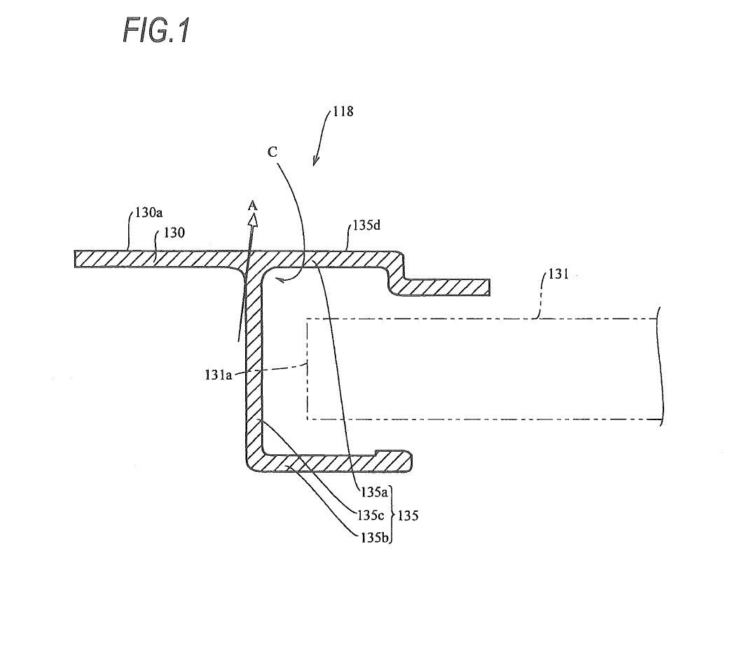

Here, the sectional shape of the lower sash 118 will be described with reference to FIG. 1. FIG. 1 is a cross-sectional view of the lower sash (sash member) according to an embodiment of this disclosure, when taken along cutting line I-I of FIG. 2. As shown in the figure, the lower sash 118 is an extruded or pultruded member made of aluminum. The lower sash includes: a body portion 135, which has a first sidewall 135a facing one side of a door glass 131, a second sidewall 135b facing the other side of the door glass 131, and a bottom wall 135c that connects base ends of the first sidewall 135a and the second sidewall 135b and faces an end face 131a along a thickness direction of the door glass 131; and a fin potion 130 extending from the bottom wall 135c.

The fin portion 130 of the present embodiment extends from a corner C between the first sidewall 135a and the bottom wall 135c and has a surface 130a flush with a surface 135d opposite to a surface, which faces the door glass, of the first sidewall 135a. That is, there is no step between the fin portion 130 and the first sidewall 135a.

When the lower sash 118 is extruded or pultruded, the fin portion 130 is entirely formed on the front surface of the lower sash 118 along the longitudinal direction. However, as shown in FIG. 2, after the lower sash is extruded or pultruded, the lower portion of the lower sash 118 is cut and removed, and the bracket 125 is provided in the cut face.

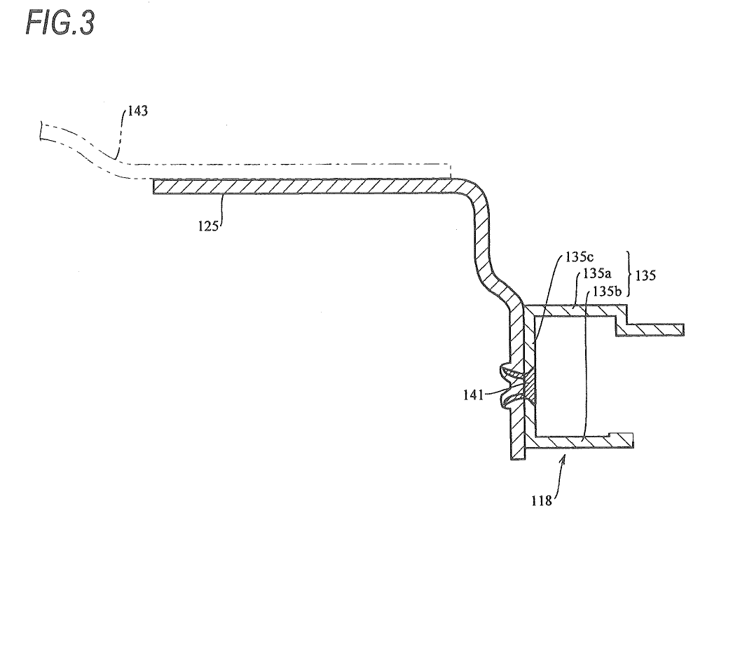

The mounting of the lower sash 118 whose fin portion 130 is cut and the bracket 125 will be described with reference to FIG. 3. FIG. 3 is a cross-sectional view taken along line III-III of FIG. 2. One end of the bracket 125 is attached to the bottom wall 135c of the lower sash 118, in which the fin portion 130 is cut, by means of a rivet (self-piercing rivet: SPR) 141. The other end of the bracket 125 is attached to the inner panel 143 of the door by means of welding or a rivet (self-piercing rivet: SPR).

According to the present embodiment, the fin portion 130 extends from the corner C between the first sidewall 135a and the bottom wall 135c and has the surface 130a flush with a surface 135d opposite to a surface, which faces the door glass 131, of the first sidewall 135a. Thus, as shown with the arrow A in FIG. 1, the fin portion 130 is cut such that a cut face is flush with the adjacent face or is recessed from the adjacent face. In the meantime, the wording “flush with” also includes a case where a protrusion or recess having several tens of microns of level is provided.

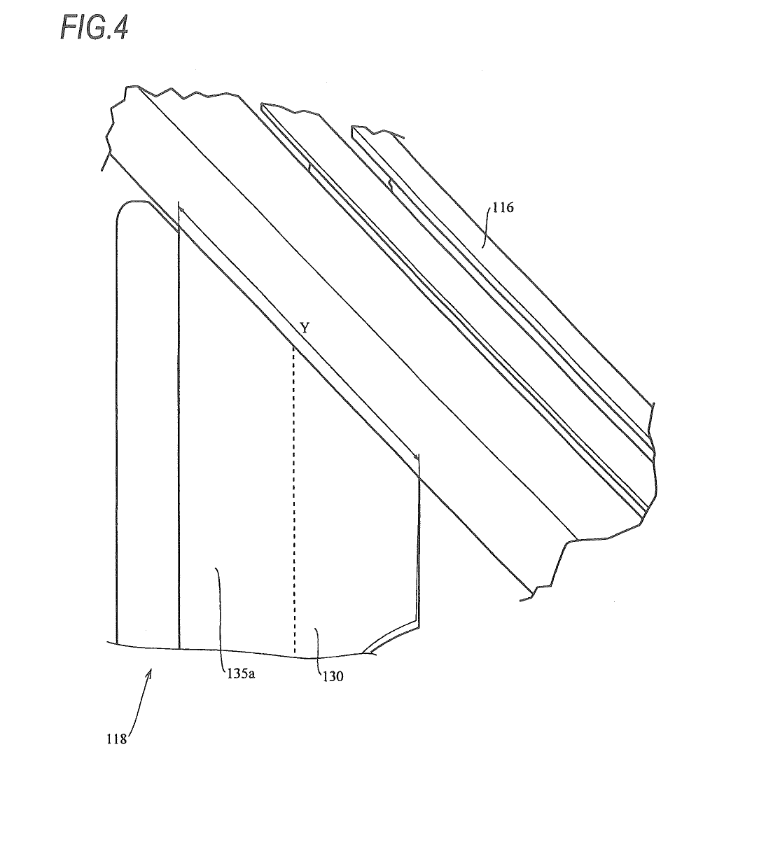

Next, the mounting of the upper sash and the upper portion of the lower sash will be described with reference to FIG. 4. FIG. 4 is a perspective view of a mounting section between the upper sash and the upper portion of the lower sash, as viewed from the inside of a vehicle. As shown in the figure, a weld portion Y is formed along the first sidewall 135a and the fin portion 130.

According to the above-mentioned configuration, the following effects can be obtained.

(1) The fin portion 130 extends from a corner C between the first sidewall 135a and the bottom wall 135c and has a surface 130a flush with a surface 135d opposite to a surface, which faces the door glass 131, of the first sidewall 135a.

That is, there is no step between the fin portion 130 and the first sidewall 135a. Thus, the sectional shape of the lower sash 118 is simplified, thereby providing good extrusion or pultrusion formability.

(2) Since there is no step between the fin portion 130 and the first sidewall 135a, the shape of a die becomes simplified, so that the bending workability of the lower sash 118 is improved.

(3) Since the fin portion 130 extends from a corner C between the first sidewall 135a and the bottom wall 135c and has a surface 130a flush with a surface 135d opposite to a surface, which faces the door glass 131, of the first sidewall 135a, the fin portion 130 can be cut such that a cut face is flush with the adjacent face or is recessed from the adjacent face. That is, since the fin portion 130 is cut such that a cut face does not protrude from the adjacent face, a component such as a bracket or the like can be attached to the cut face of the fin portion 130.

(4) Since the weld portion Y is formed along the first sidewall 135a and the fin portion 130, welding is easily performed.

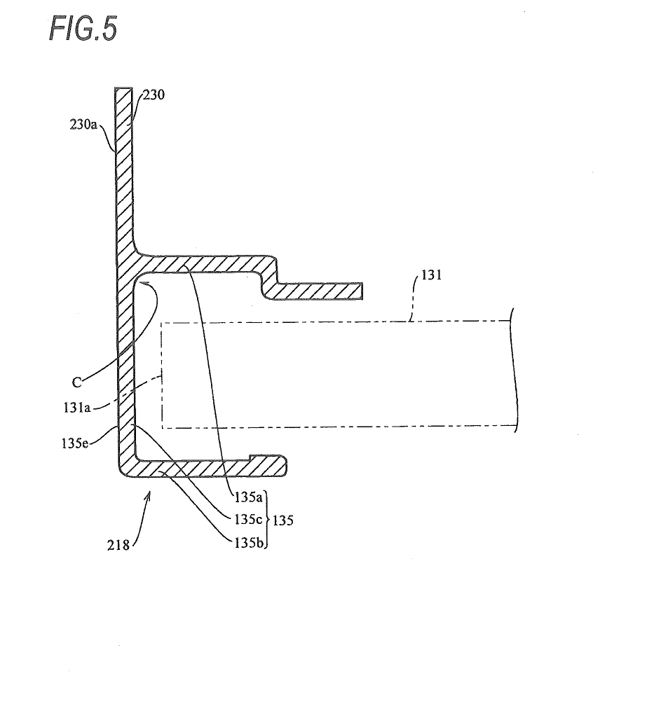

In the meantime, this disclosure is not limited to the above-mentioned embodiments. Although the embodiments has illustrated that the fin portion 130 extends from the corner C between the first sidewall 135a and the bottom wall 135c and has the surface 130a flush with a surface 135d opposite to a surface, which faces the door glass 131, of the first sidewall 135a, as shown in FIG. 5, a fin portion 230 of a lower sash 218 may extends from the corner C between the first sidewall 135a and the bottom wall 135c and may have a surface 230a flush with a surface 135e opposite to a surface, which faces the door glass 131, of the bottom wall 135c.

What is claimed is:

1. A door sash including a sash member, the sash member comprising:
a body portion having:
a first sidewall facing one side of a door glass;
a second sidewall facing the other side of the door glass; and
a bottom wall that connects base ends of the first side wall and the second sidewall and faces a end face along a thickness direction of the door glass; and
a fin portion which extends from a corner between the first sidewall and the bottom wall and has a surface flush with a surface opposite to a surface, which faces the door glass, of either one of the first sidewall and the bottom wall, and
wherein the sash member is bent in a width direction of a vehicle.

2. The door sash according to claim 1,
wherein the fin portion is cut such that a cut face is flush with an adjacent face or is recessed from the adjacent face.

3. The door sash according to claim 1,
wherein a weld portion is formed along the fin portion and one of the first sidewall and the bottom wall.

4. The door sash according to claim 2,
wherein a weld portion is formed along the fin portion and one of the first sidewall and the bottom wall.

5. The door sash according to claim 1,
wherein the fin portion is flush with a surface opposite to a surface, which faces the door glass, of the first sidewall.

6. The door sash according to claim 3, comprising:
au upper sash configuring a front edge part and an upper edge part;
a rear sash configuring a rear edge part; and
wherein the weld portion is positioned between the upper sash and the sash member.

7. The door sash according to claim 2, comprising:
wherein a bracket is provided on the cut face of the fin portion.
